(19) United States
(12) Patent Application Publication
(10) Pub. No.: US 2011/0020207 A1
(43) Pub. Date: Jan. 27, 2011

(54) METHOD FOR PRODUCING HYDROGEN CYANIDE IN A PARTICULATE HEAT EXCHANGER CIRCULATED AS A MOVING FLUIDIZED BED

(75) Inventor: Hermann Siegert, Seeheim-Jugenheim (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: Evonik Roehm GmbH, Darmstadt (DE)

(21) Appl. No.: 12/934,205

(22) PCT Filed: Jun. 5, 2009
(86) PCT No.: PCT/EP2009/056911

§ 371 Date: Sep. 23, 2010

(30) Foreign Application Priority Data
Jun. 6, 2008 (DE) 10 2008 002 258.6

(51) Int. Cl. C01C 3/02

(52) U.S. Cl. 423/375

(57) ABSTRACT

The invention relates to a process for continuously preparing hydrogen cyanide by reacting ammonia with hydrocarbons, the reaction gas mixture being brought to reaction temperature in the fluidized bed by means of indirect heating by contact with a particulate heat transferrer, and which is characterized in that the heat transferrer is conducted cyclically in a transported fluidized bed, the heat transferrer being heated in an ascending transport stream and being contacted with the reaction gas mixture in a descending transport stream.

The invention relates to a process for preparing hydrogen cyanide over a particulate heat transferrer conducted cyclically as a transported fluidized bed.

Hydrogen cyanide (HCN, hydrocyanic acid) is typically prepared industrially from methane and ammonia in the gas phase according to the reaction equation

CH₄+NH₃→HCN+3H₂.

The reaction proceeds highly endothermically at 252 kJ/mol and therefore requires a large input of thermal energy and, for thermodynamic reasons, a very high reaction temperature, usually above 1000° C. This reaction is typically conducted continuously.

Essentially three processes have become established as industrial processes for preparing hydrogen cyanide.

In the Andrussow process, the chemical conversion is effected over metallic Pt/Rh meshes at approx. 1150° C. The energy input is effected here by parallel combustion of methane and ammonia with oxygen at the same reaction site. The oxygen supplier used is either air or oxygen-enriched air up to pure oxygen. The Andrussow process is simple in terms of plant and process technology and therefore requires comparatively low capital costs. However, as a result of the simultaneous combustion reaction for the energy input, the yield of HCN, based on NH₃, is relatively low at approx. 64%. In addition, the HCN concentration is very low at approx. 7% by volume as a result of dilution with the combustion gases formed in parallel, which leads to an increased level of complexity in the subsequent removal of HCN. The volumes of the downstream process gas lines also have to be correspondingly large for the same reasons.

In the BMA process (abbreviation of “hydrocyanic acid from methane and ammonia” in German), the reaction is effected at approx. 1200° C. in ceramic tubes covered internally with catalyst, which are fired externally with a heating gas for the purpose of energy input. The BMA process overcomes the disadvantages of the Andrussow process advantageously by indirect heating of the reaction and achieves a yield of HCN, based on NH₃, of more than 80% at an HCN concentration in the synthesis gas converted of more than 20% by volume. However, this advantage is at the cost of a considerable disadvantage arising from the complexity of the plant and of the process. For instance, for a production plant with an industrially customary production capacity of, for example, 30 000 tonnes of HCN per year, approx. 6000 ceramic tubes are required, which have to be connected to the flow individually and shut off individually for the purpose of exchange. The tubes consist typically of Al₂O₃. These only have a limited service life which is different in each individual case under the high-temperature conditions and with the accompanying partial conversion to AIN over the operating time. This considerably increases the complexity of the process, which is reflected in very high capital and operating costs in spite of a good HCN yield.

In the Shawinigan process, the reaction is performed above 1200° C. in a coke fluidized bed, the thermal energy being supplied in the form of electrical energy via high-voltage electrodes. The Shawinigan process, even though it is relatively elegant in terms of process technology, is a process heated by electrical energy. Electrical energy can nowadays only be generated with an efficiency of approx. ⅓ of the thermally available primary energy. Indirect secondary energy supply to this process is therefore disproportionately costly, and so this process is implemented only in special regions and only in very small plants. It is uneconomic for industrial scale use owing to very high variable production costs and for energetic reasons.

Other fluidized bed processes for preparing hydrogen cyanide described to date have not become established industrially because they were either of excessive technical complexity or failed for purely technical reasons due to the relevant thermal expansion problems and material requirements at extremely high temperatures as a result of their specific construction parameters, and in particular because the problem of energy input has not been solved in a sufficiently economically attractive manner.

All known processes therefore have technical and economic disadvantages which have to be overcome.

It has now been found that, surprisingly, this objective can be achieved by a process for continuously preparing hydrogen cyanide by reacting ammonia with hydrocarbons, the reaction gas mixture being brought to reaction temperature in the fluidized bed by means of indirect heating by contact with a particulate heat transferrer, in which the heat transferrer is conducted cyclically in a transported fluidized bed, the heat transferrer being heated in an ascending transport stream and being contacted with the reaction gas mixture in a descending transport stream.

The present invention thus provides a process for continuously preparing hydrogen cyanide by reacting ammonia with hydrocarbons, the reaction gas mixture being brought to reaction temperature in the fluidized bed by means of indirect heating by contact with a particulate heat transferrer, and which is characterized in that the heat transferrer is conducted cyclically in a transported fluidized bed, the heat transferrer being heated in an ascending transport stream and being contacted with the reaction gas mixture in a descending transport stream.

The starting point for the idea leading to the present invention is to exploit the advantage of the high yield and the high HCN concentration in the product stream of the BMA process, but simultaneously to avoid the conduct of the reaction gas mixture through a multitude of stationary, externally fired ceramic tubes, which is disadvantageous in terms of plant and process technology. The core idea of the invention is instead to undertake the indirect introduction of heat by means of a particulate heat transferrer in a migrating transported fluidized bed. In this case, heating of the heat transferrer and the release of heat to the reaction gas mixture have to be effected separately in terms of time and space, though the heat transferrer is conducted cyclically. The heat transferrer is heated in an ascending transport stream and is contacted with the reaction mixture and converted therewith in a descending transport stream.

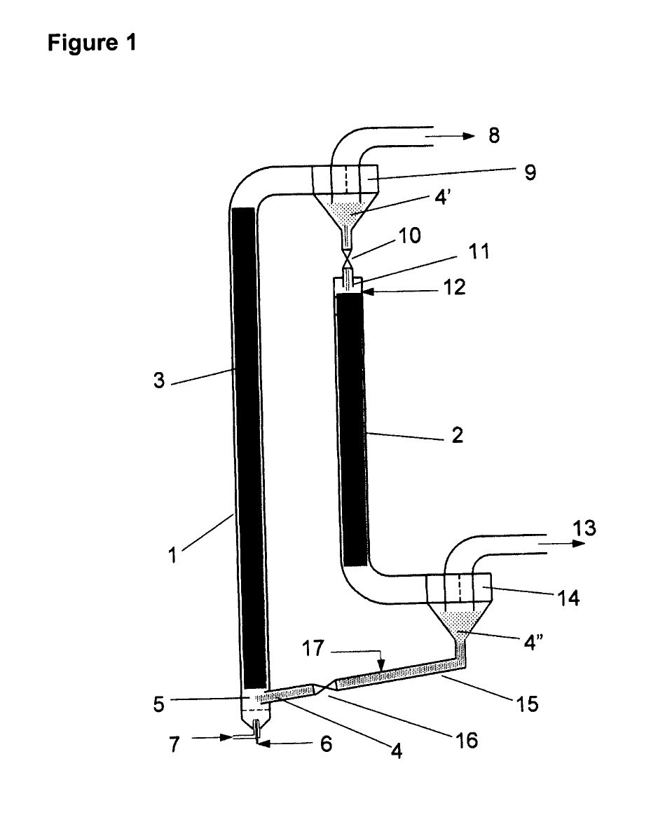

FIG. 1 shows, by way of example, a schematic diagram of the inventive process principle and a corresponding plant.

Two vertically positioned tubular reactors (1, 2) are connected to one another in circulation. In the tubular reactor (1), “riser”, the fluidization and heating (3) of the particulate heat transferrer (4) initially charged or supplied in the lower region is effected in an ascending transport stream by means of a heating gas stream (5) which is supplied there or appropriately generated by combusting a fuel mixture (6, 7). At the top of the tubular reactor (1), the transported fluidized bed is removed and fed to a material separation of hot particulate heat transferrer (4′) and gas stream, which is discharged as offgas (8). Appropriately, the separation of the gas-solid particle phase is effected in a cyclone (9). The hot heat transferrer particles (4′) pass via a metering apparatus (10) into the top (11) of the tubular reactor (2), “downer”, where the reaction gas mixture composed of ammonia and hydrocarbons (12) is supplied, which is brought abruptly to reaction temperature by the direct contact with the hot heat transferrer particles. The conversion to hydrogen cyanide proceeds in a descending transport stream in the tubular reactor (2), in the transported fluidized bed which migrates by the plug-flow principle. At the lower end of the tubular reactor (2), the transported fluidized bed is removed and fed again to a material separation of hot particulate heat transferrer (4″) and gas stream, which is discharged as product gas (13). Appropriately, the separation of the gas-solid particle phase is effected in a cyclone (14) here too. The heat transferrer particles (4″) removed are recycled via a pipeline (15) with a metering apparatus (16) into the lower region of the tubular reactor (1). Via a feed line (17) to the pipe-line (18), the particulate heat transferrer removed from the gas stream can be purged with a purge gas to purge back the gas content of the intermediate particles.

Plants suitable for the process according to the invention can be designed, configured and constructed in a manner known per se. The plant components can be produced from the materials suitable for high-temperature processes. It is a significant advantage that all plant components of this high-temperature process can be implemented in the form of assemblies reinforced with refractory materials.

The particulate heat transferrer used is ceramic material. This consists preferably in each case essentially of aluminium oxide, aluminium nitride or a mixed phase of aluminium oxide and aluminium nitride.

Aluminium oxide and aluminium nitride possess catalytic properties for the BMA process, aluminium oxide possessing a higher activity than aluminium nitride. In the course of prolonged contact with the ammonia-hydrocarbon synthesis gas, aluminium oxide is gradually converted partially to aluminium nitride, as a result of which the catalytic activity falls and the yield of HCN decreases.

The process according to the invention does not have this disadvantage. This is in turn because of the separation in terms of space and time of heating phase and reaction phase, since the heating phase can be controlled such that, for instance, aluminium nitride formed is oxidized, i.e. is converted back to aluminium oxide.

Advantageously, the catalytic properties of the particulate heat transferrer can be enhanced, by doping it with one of more elements from the group of platinum, palladium, iridium, rhodium, copper and nickel, and possible other elements. Corresponding particulate ceramic catalyst materials are known per se and are identical or virtually identical to catalysts as used for cracking, reforming and platforming processes in mineral oil processing.

The heating gas stream which serves to fluidize and heat the particulate heat transferrer in the ascending transport stream (“riser”) is preferably obtained by combusting a fuel mixture. The heating gas stream can be obtained by combusting hydrogen, methane, natural gas, higher hydrocarbons or mixtures of these fuels with air, an air-oxygen mixture or oxygen. For the combustion, in addition to external fuels, it is also possible to use remaining residual gases of this process, which, in this case, consist essentially of hydrogen, or any residual gases which occur at the site of this chemical process.

In the case of use of higher hydrocarbons, it is advisable to additionally use hydrogen to prevent carbon deposits. Overall, the process according to the invention, in contrast to the conventional BMA process, is very insensitive to carbon deposits on the particulate heat transferrer, both in the heating phase and in the reaction phase, such that it is possible, instead of very pure methane gas, also to use lower qualities and other hydrocarbons, especially higher hydrocarbons. This is because of the separation in terms of space and time of heating phase and reaction phase, since the heating phase can be controlled such that any carbon deposits are burnt off.

Flow rate, temperature control and residence time of the particulate heat transferrer in the heating phase in the ascending transport stream are controlled. This is followed by a material separation of the heating gas/particle flow, appropriately by means of a cyclone, from which the heating gas is discharged from the process to a possible further use or as offgas.

The hot particulate heat transferrer is contacted with the reaction gas mixture in a descending transport stream (“downer”), wherein the ammonia-hydrocarbon synthesis gas is converted to hydrogen cyanide. It is found that the abrupt heating of the synthesis gas mixture which is characteristic of the process according to the invention leads to very high yields. This is achieved by the process according to the invention by virtue of the fluidized particulate heat transferrer superheated in a defined manner being contacted very rapidly with the synthesis gas and then migrating within a transported fluidized bed by the plug-flow principle.

The reaction gas mixture composed of ammonia and hydrocarbons with or without hydrogen is converted at temperatures of 750 to 1200° C., preferably at 800 to 900° C. This is followed by the material separation of the product gas/particle flow, appropriately by means of a cyclone, from which the product gas is discharged from the process for further workup and isolation of hydrogen cyanide. The synthesis gas converted is separated in a customary manner to obtain hydrogen cyanide, and worked up in the manner known in the conventional processes.

After the removal of the product gas, the particulate heat transferrer is recycled into the heating phase in the circulation system. It is appropriate here to purge the particulate heat transferrer removed from the product gas stream with a purge gas to purge back the gas content of the intermediate particles. The purge gas may in each case consist essentially of hydrogen, methane or of partly recycled offgas of the heating gas stream.

The process according to the invention has numerous advantages, some of them unexpected, over the known processes for preparing hydrogen cyanide. For instance, the product yield is at least within the order of magnitude of the conventional BMA process, and even significantly higher, and affords a significantly higher HCN concentration in the product gas. It is significantly simpler and hence less expensive in terms of plant and process technology compared to the conventional BMA process. The process according to the invention will be described hereinafter by way of example by the dimensions of a pilot plant.

### EXPERIMENTAL EXAMPLES

A pilot plant according to FIG. 1, which was established for example tests, had the following dimensions:

Tubular reactor 1=riser:

Internal diameter: 80 mm

Length: 6700 mm

Tubular reactor 2=downer:

Internal diameter: 50 mm

Length: 2000 mm

Deposition vessel of the cyclone 9:

Internal diameter: 600 mm

Height: 900 mm

Deposition vessel of the cyclone 14:

Internal diameter: 266 mm

Height: 625 mm

The construction consisted of an outer metal jacket with a complete inner lining of aluminium oxide and a fibre ceramic in between to balance thermal stresses. For substantial prevention of heat losses, the plant was surrounded on the outside with a 400 mm-thick quartz wool insulation, which was provided in the middle, within this layer, additionally with electrically supplied support heating at a level of 500° C. A further cyclone was connected downstream of each of cyclone 9 and cyclone 14 for substantially complete particle separation.

All streams which could be influenced from the outside were controlled or regulated by means of a process control system.

The individual streams of the reaction mixture No. 12 were each defined or set as a fixed parameter.

The amounts of fuel were regulated such that the temperature in the offgas No. 8 and also the temperature of the hot heat carrier 4′ which is thus identical reached the desired value.

The metering apparatus No. 10 was regulated such that the desired product gas temperature was reached in the product gas No. 13, and the metering apparatus No. 16 such that the fill level in the deposition vessel of the cyclone 14 was kept constant.

### Example 1

The particulate heat carrier/catalyst used was an aluminium oxide with the name Puralox SCCa 150-200 from Sasol Germany with an average particle size d₅₀ of 150 micrometres.

In the steady state, according to the above regulation strategy, the following streams were run:

| | | | |
|---|---|---|---|
| No. 12 | reaction gas component 1 = ammonia | 1.55 | kg/h |
| No. 12 | reaction gas component 2 = methane | 1.46 | kg/h |
| No. 6 | fuel component 1 = hydrogen | 1.20 | kg/h |
| No. 7 | fuel component 2 = air | 43.26 | kg/h |

| | | |
|---|---|---|
| Amount of the heat carrier circulating | 170.44 | kg/h |

(calculated indirectly)

The resulting temperature in the offgas No. 8 was 1030° C., and that in the product gas No. 13 was 880° C.

After an operating time of 9 hours, the following steady-state reaction result was obtained in the product gas No. 13:

| | | | |
|---|---|---|---|
| Composition by gas chromatography: | HCN | 23.5% | by vol. |
| | hydrogen | 72.7% | by vol. |
| | nitrogen | 1.3% | by vol. |
| | methane | 2.5% | by vol. |
| | ammonia | 0% | by vol. |

The amount of HCN collected by mass balance over 2 hours in a downstream scrubber with NaOH solution was 2.238 kg/h. This corresponds to a yield based on the amount of ammonia used of 90.9%.

### Example 2

The test in Example 1 was repeated, except that the particulate heat carrier/catalyst used was coated with platinum (by means of hexachloroplatinate solution and subsequent reduction with hydrogen at 500° C./5 h). The platinum coating was 1.49% by weight.

After an operating time of 7 hours, the following steady-state reaction result was obtained in the product gas No. 13:

| | | | |
|---|---|---|---|
| Composition by gas chromatography: | HCN | 23.8% | by vol. |
| | hydrogen | 72.8% | by vol. |
| | nitrogen | 1.1% | by vol. |
| | methane | 2.3% | by vol. |
| | ammonia | 0% | by vol. |

The amount of HCN collected by mass balance over 2 hours in a downstream scrubber with NaOH solution was 2.267 kg/h. This corresponds to a yield based on the amount of ammonia used of 92.1%.

### EXPLANATION OF THE REFERENCE NUMERALS

| Number | Name |
|---|---|
| 1 | Tubular reactor 1 |
| 2 | Tubular reactor 2 |
| 3 | Heating zone in tubular reactor 1 |
| 4 | Heat transferrer |
| 4′ | Hot particulate heat transferrer |
| 4″ | Hot particulate heat transferrer |
| 5 | Heating gas stream |
| 6 | Fuel mixture component 1 |
| 7 | Fuel mixture component 2 |
| 8 | Offgas |
| 9 | Cyclone |
| 10 | Metering apparatus |
| 11 | Top |
| 12 | Reaction mixture composed of ammonia and |
| | hydrocarbons |
| 13 | Product gas |
| 14 | Cyclone |
| 15 | Pipeline |
| 16 | Metering apparatus |
| 17 | Feed line |

1. A process for continuously preparing hydrogen cyanide by reacting ammonia with at least one hydrocarbon, the process comprising bringing a reaction gas mixture comprising the ammonia and the at least one hydrocarbon to reaction temperature in a transported fluidized bed by through indirect heating by contact with a particulate heat transferrer, wherein
the particulate heat transferrer is conducted cyclically in the transported fluidized bed,
the particulate heat transferrer is heated in an ascending transport stream, and
the particulate heat transferrer is contacted with the reaction gas mixture in a descending transport stream.

2. The process according to claim 1, wherein the reaction gas mixture comprising ammonia and the at least one hydrocarbon, with or without hydrogen, is converted at a temperature in a range of 750 to 1200° C.

3. The process according to claim 1, wherein a fluidization and heating of the particulate heat transferrer in the ascending transport stream is brought about by a heating gas stream generated by combustion.

4. The process according to claim 3, wherein the heating gas stream is obtained by combusting at least one selected from the group consisting of hydrogen, methane, natural gas, and higher hydrocarbons, or with air, an air-oxygen mixture, or oxygen.

5. The process according to claim 1, wherein a material separation of the particulate heat transferrer and gas stream is effected in each case downstream of the ascending and descending transport streams of the transported fluidized bed.

6. The process according to claim 5, wherein separation of the particulate heat transferrer and gas stream is effected by cyclones.

7. The process according to claim 6, wherein the particulate heat transferrer removed from the gas stream is purged with a purge gas to purge back a gas content of intermediate particles.

8. The process according to claim 7, wherein the purge gas comprises hydrogen, methane, or an offgas of a heating gas stream.

9. The process according to claim 1, wherein the particulate heat transferrer comprises aluminium oxide, aluminium nitride, or a mixed phase of aluminium oxide and aluminium nitride.

10. The process according to claim 9, wherein the particulate heat transferrer is doped with at least one element selected from the group consisting of platinum, palladium, iridium, rhodium, copper, and nickel.

11. The process according to claim 1, wherein the reaction gas mixture comprising ammonia and the at least one hydrocarbon, with or without hydrogen, is converted at a temperature in a range of 800 to 900° C.

12. The process according to claim 2, wherein a material separation of the particulate heat transferrer and gas stream is effected in each case downstream of the ascending and descending transport streams of the transported fluidized bed.

13. The process according to claim 3, wherein a material separation of the particulate heat transferrer and gas stream is effected in each case downstream of the ascending and descending transport streams of the transported fluidized bed.

14. The process according to claim 4, wherein a material separation of the particulate heat transferrer and gas stream is effected in each case downstream of the ascending and descending transport streams of the transported fluidized bed.

15. The process according to claim 11, wherein separation of the particulate heat transferrer and gas stream is effected by cyclones.

16. The process according to claim 12, wherein separation of the particulate heat transferrer and gas stream is effected by cyclones.

17. The process according to claim 13, wherein separation of the particulate heat transferrer and gas stream is effected by cyclones.

18. The process according to claim 14, wherein the particulate heat transferrer removed from the gas stream is purged with a purge gas to purge back a gas content of intermediate particles.

19. The process according to claim 15, wherein the particulate heat transferrer removed from the gas stream is purged with a purge gas to purge back a gas content of intermediate particles.

20. The process according to claim 16, wherein the particulate heat transferrer removed from the gas stream is purged with a purge gas to purge back a gas content of intermediate particles.
